(19) United States
(12) Patent Application Publication
(10) Pub. No.: US 2026/0074121 A1
(43) Pub. Date: Mar. 12, 2026

(54) MULTILAYER CERAMIC ELECTRONIC DEVICE AND METHOD OF MANUFACTURING THE SAME

(71) Applicant: TDK CORPORATION, Tokyo (JP)

(72) Inventors: Momoyo SASAKI, Tokyo (JP); Kosuke TAKANO, Tokyo (JP); Hsing-Wen YEH, Tokyo (JP)

(73) Assignee: TDK CORPORATION, Tokyo (JP)

(21) Appl. No.: 19/321,641

(22) Filed: Sep. 8, 2025

(30) Foreign Application Priority Data
Sep. 12, 2024 (JP) 2024-158325

(51) Int. Cl. H01G 4/30; H01G 4/12

(52) U.S. Cl. CPC H01G 4/30; H01G 4/1227

(57) ABSTRACT

A multilayer ceramic electronic device includes an element body including a dielectric layer and an internal electrode layer. The dielectric layer and the internal electrode layer are laminated. The dielectric layer includes dielectric grains containing a main component represented by a formula A¹B¹O₃, where A¹ includes Ba and at least one selected from the group consisting of Ca and Sr or includes only Ba, and B¹ includes Ti and Zr or includes only Ti. The dielectric grains include electrode-contacting grains in contact with the internal electrode layer and porous grains having a pore in a section parallel to a lamination direction. A number ratio of the dielectric grains that fall under both the electrode-contacting grains and the porous grains to the electrode-contacting grains is 0.1% or more and 15.0% or less.

### TECHNICAL FIELD

The present disclosure relates to a multilayer ceramic electronic device and a method of manufacturing the same.

### BACKGROUND

Patent Document 1 describes an invention related to a multilayer ceramic capacitor. Having structures such as dielectric layers composed of barium titanate crystal grains with pores inside, a multilayer ceramic capacitor with high reliability for an accelerated life test can be provided, even when the dielectric layers are thinned.
Patent Document 1: WO 2007/074731

### SUMMARY

It is an object of the present disclosure to provide a multilayer ceramic electronic device with high reliability and suitable relative permittivity and a method of manufacturing the same.

To achieve the above object, a multilayer ceramic electronic device according to the present disclosure is
a multilayer ceramic electronic device including an element body including a dielectric layer and an internal electrode layer, the dielectric layer and the internal electrode layer being laminated,
wherein
the dielectric layer includes dielectric grains containing a main component represented by a formula A¹B¹O₃, where A¹ includes Ba and at least one selected from the group consisting of Ca and Sr or includes only Ba, and B¹ includes Ti and Zr or includes only Ti,
the dielectric grains include electrode-contacting grains in contact with the internal electrode layer and porous grains having a pore in a section parallel to a lamination direction, and
a number ratio of the dielectric grains that fall under both the electrode-contacting grains and the porous grains to the electrode-contacting grains is 0.1% or more and 15.0% or less.

The dielectric layer may have a thickness of 1 μm or less, and the number of the dielectric layer may be 100 or more.

The dielectric grains may include electrode-noncontacting grains not in contact with the internal electrode layer in the section parallel to the lamination direction, and a number ratio of the dielectric grains that fall under both the electrode-noncontacting grains and the porous grains to the electrode-noncontacting grains may be 0.1% or more and 15% or less.

The internal electrode layer may include an inside-electrode dielectric grain containing a main component represented by a formula A²B²O₃, where A² includes Ba and at least one selected from the group consisting of Ca and Sr or includes only Ba, and B² includes Ti and Zr or includes only Ti.

A²B²O₃ and A¹B¹O₃ may be substantially the same.

A²B²O₃ may include BaTiO₃.

A method of manufacturing a multilayer ceramic electronic device according to the present disclosure is a method of manufacturing a multilayer ceramic electronic device, including forming an internal electrode layer on a ceramic green sheet using an internal electrode layer paste,
wherein
the internal electrode layer paste includes a metal powder and an inhibitor,
the inhibitor includes dielectric particles represented by a formula A²B²O₃, where A² includes Ba and at least one selected from the group consisting of Ca and Sr or includes only Ba, and B² includes Ti and Zr or includes only Ti,
the dielectric particles include porous dielectric particles having a pore inside, a number ratio of the porous dielectric particles to the dielectric particles is 1.0% or more and 40% or less, and
an amount of the inhibitor is 8 parts by weight or more and 20 parts by weight or less with respect to 100 parts by weight of the metal powder.

A²B²O₃ may include BaTiO₃.

### BRIEF DESCRIPTION OF THE DRAWING(S)

FIG. 1 is a sectional view of a multilayer ceramic capacitor according to one embodiment of the present disclosure.

FIG. 2 is an enlarged schematic sectional view of a main part of FIG. 1.

### DETAILED DESCRIPTION

The present disclosure is described below with reference to an embodiment illustrated in the drawings.

### Multilayer Ceramic Capacitor 1

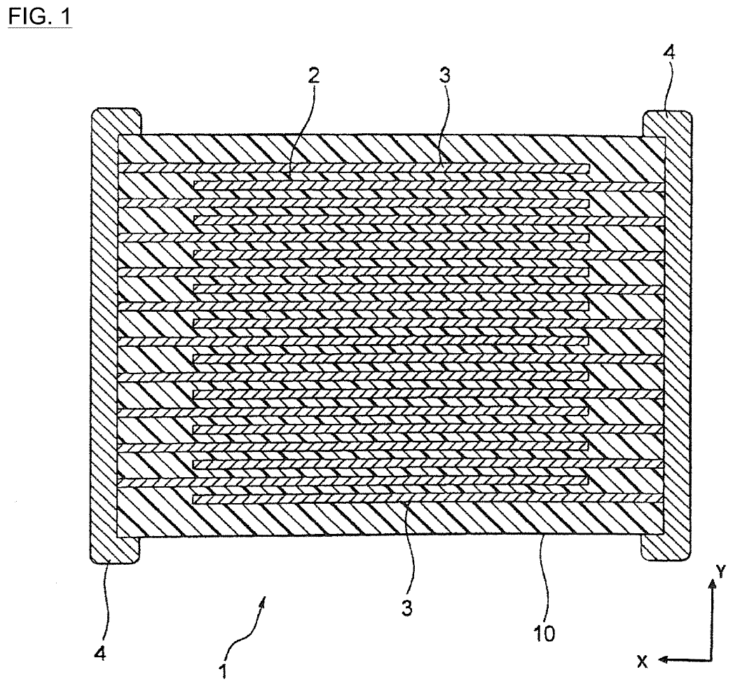

As shown in FIG. 1, a multilayer ceramic capacitor 1, which is one type of multilayer ceramic electronic device according to one embodiment of the present disclosure, includes a capacitor element body 10 including dielectric layers 2 and internal electrode layers 3 alternately laminated. The internal electrode layers 3 are laminated so that their end surfaces are alternately exposed to surfaces of ends of the capacitor element body 10 facing each other. External electrodes 4 in pairs are provided at both ends of the capacitor element body 10 and are connected to the exposed end surfaces of the alternately arranged internal electrode layers 3 to form a capacitor circuit.

The capacitor element body 10 may have any shape but normally has a rectangular parallelepiped shape as shown in FIG. 1. The capacitor element body 10 may also have any dimensions. The dimensions are appropriately determined according to a use.

### Dielectric Layers 2

The dielectric layers 2 include dielectric grains containing a main component represented by a formula A¹B¹O₃ (A¹ includes Ba and at least one selected from the group consisting of Ca and Sr or includes only Ba, and B¹ includes Ti and Zr or includes only Ti).

The dielectric grains may contain a component other than the main component. Examples of components other than the main component include various oxides. The various oxides may include simple oxides or complex oxides. The proportion of the component other than the main component in the dielectric grains is not limited and may fall within a range that does not significantly influence performance of the multilayer ceramic capacitor 1. The proportion may be, for example, 0 wt % or more and 5 wt % or less.

The above main component may be BaTiO₃. That is, A¹ and B¹ may be a combination of only Ba and only Ti. Note that BaTiO₃ contains a compound represented by a composition formula BaₘTiO₂₊ₘ, where m is 0.995≤m≤1.010.

The dielectric layers 2 may have any thickness. The thickness (interlayer thickness) of the dielectric layers 2 may be 1 μm or less or may be 0.4 μm or more and 1 μm or less. The number of the dielectric layers 2 is not limited. The number of the dielectric layers 2 may be one hundred or more or may be one hundred or more and one thousand or less.

### Internal Electrode Layers 3

The internal electrode layers 3 may contain any conductive material. Because a constituent material of the dielectric layers 2 has resistance to reduction, as the conductive material, a relatively inexpensive base metal material can be used. The base metal material used as the conductive material may be Ni or a Ni alloy. The Ni alloy may be an alloy of Ni and at least one element selected from Mn, Cr, Co, Cu, Sn, and Al. The Ni content of the Ni alloy may be 95 wt % or more. Note that the base metal material may contain about 0.1 wt % or less each of various trace components, such as P.

The internal electrode layers 3 may have any thickness. The thickness (interlayer thickness) of the internal electrode layers 3 may be 1.0 μm or less or may be 0.4 μm or more and 0.8 μm or less.

### Microstructures of Dielectric Layers 2 and Internal Electrode Layers 3

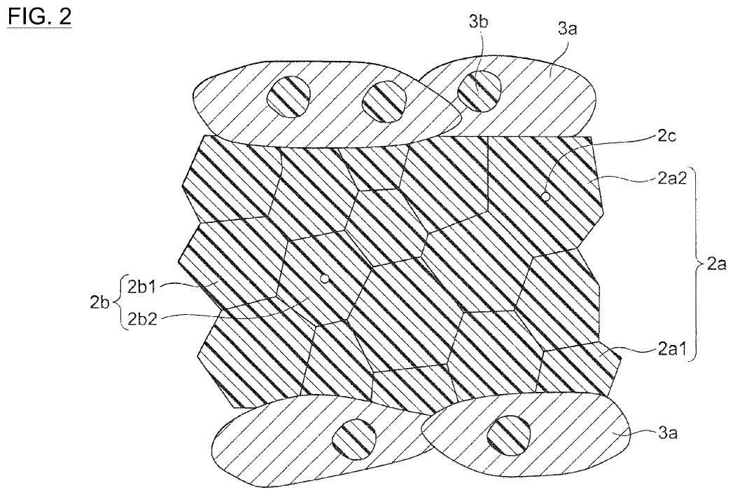

FIG. 2 is an enlarged schematic sectional view of a main part where the dielectric grains and internal electrode grains 3a are visibly shown.

As shown in FIG. 2, the dielectric grains are classified into electrode-contacting grains 2a, which are in contact with at least one of the internal electrode layers, and electrode-noncontacting grains 2b, which are not in contact with the internal electrode layers.

Provided that the minimum distance between a dielectric grain and an internal electrode grain described later is 0 nm or more and 2 nm or less, the dielectric grain is deemed to be an electrode-contacting grain 2a, which is in contact with at least one of the internal electrode layers 3.

Some of the dielectric grains are porous grains with a pore 2c inside. The electrode-contacting grains 2a are classified into non-porous grains 2al and porous grains 2a2. The electrode-noncontacting grains 2b are classified into non-porous grains 2b1 and porous grains 2b2.

The number ratio of the dielectric grains that fall under both the electrode-contacting grains and the porous grains to the electrode-contacting grains is 0.1% or more and 15.0% or less. That is, the number ratio of the porous grains 2a2 to the electrode-contacting grains 2a is 0.1% or more and 15.0% or less. The number ratio may be 0.2% or more and 14.7% or less. In other words, the number ratio of the porous grains 2a2 to the total of the non-porous grains 2al and the porous grains 2a2 is 0.1% or more and 15.0% or less.

In a situation where the number ratio of the grains that fall under both the electrode-contacting grains and the porous grains to the electrode-contacting grains is within the predetermined range, the multilayer ceramic capacitor 1 has high reliability. Too low or too high an above number ratio decreases the reliability of the multilayer ceramic capacitor 1. Note that the reliability can be evaluated using the time it takes for the insulation resistance to decrease in an accelerated test and high-temperature load life.

In a situation where the above number ratio is too high, relative permittivity is readily decreased. Along with a decrease in relative permittivity, capacitance is readily decreased.

In a situation where the above number ratio is too low, relative permittivity is readily increased. Along with an increase in relative permittivity, DC bias characteristics are readily impaired, and effective capacity is readily decreased. Thus, a multilayer ceramic capacitor 1 whose relative permittivity is too high is unsuitable for a use requiring a particularly small, high-capacity multilayer ceramic capacitor.

The number ratio of the dielectric grains that fall under both the electrode-noncontacting grains and the porous grains to the electrode-noncontacting grains is not limited. This number ratio may be 0.1% or more and 15.0% or less. The number ratio may be 0.1% or more and 14.8% or less. In other words, the number ratio of the porous grains 2b2 to the total of the non-porous grains 2b1 and the porous grains 2b2 may be 0.1% or more and 15.0% or less.

In a situation where the number ratio of the grains that fall under both the electrode-noncontacting grains and the porous grains to the electrode-noncontacting grains is within the predetermined range, the multilayer ceramic capacitor 1 readily has high reliability. However, the number ratio of the grains that fall under both the electrode-contacting grains and the porous grains to the electrode-contacting grains has more importance.

As a cause of a decrease in the insulation resistance of the multilayer ceramic capacitor 1 in general, known is a movement of oxygen ion vacancy (oxygen vacancy) toward a cathode for concentration near electrodes in an electric field at a high temperature and under application of a direct current. Thus, in particular, that the porous grains with a pore inside, which is a defect of various constituent elements, constitute a high proportion of the electrode-contacting grains readily decreases the insulation resistance, readily decreasing the reliability.

The conductive material contained in the internal electrode layers 3 include the internal electrode grains 3a. The internal electrode grains 3a contain the above base metal material.

The internal electrode layers 3 may include, other than the internal electrode grains 3a, inside-electrode dielectric grains 3b containing a main component represented by a formula A²B²O₃ (A² includes Ba and at least one selected from the group consisting of Ca and Sr or includes only Ba, and B² includes Ti and Zr or includes only Ti). A²B²O₃ and A¹B¹O₃ may be substantially the same. That is, the percentage of agreement between A¹ and A² may be 99% or more, and the percentage of agreement between B¹ and B² may be 99% or more. Moreover, A²B²O₃ may be BaTiO₃.

The inside-electrode dielectric grains 3b having the above composition are dielectric grains that function as an inhibitor. The internal electrode layers 3 may include other grains as necessary. Examples of other grains include grains containing oxides such as yttrium oxide, ytterbium oxide, calcium oxide, barium oxide, or magnesium oxide.

### External Electrodes 4

The external electrodes 4 may contain any conductive material. As the conductive material contained in the external electrodes 4, for example, Ni, Cu, a Ni alloy, or a Cu alloy, which are known, can be used. The external electrodes 4 may have any thickness. The thickness is appropriately determined according to a use or the like. Normally, the external electrodes 4 may have a thickness of about 5 μm to about 50 μm.

### Method of Manufacturing Multilayer Ceramic Capacitor 1

The multilayer ceramic capacitor 1 of the present embodiment is manufactured using a method similar to a method of manufacturing a conventional multilayer ceramic capacitor except for what is described later. Specifically, first, a green chip is prepared using a normal method involving a paste (e.g., a printing method or a sheet method). Then, the green chip is fired. To the fired green chip, external electrodes are printed or transferred. Then, the external electrodes are baked. This completes the manufacture. Specific description of the manufacturing method is provided below. The following description is based on the premise that the main component of the dielectric layers is BaTiO₃. However, the following method is applicable even if the main component of the dielectric layers is other than BaTiO₃.

First, as a dielectric raw material included in a dielectric layer paste described later, a dielectric powder including dielectric particles with a relatively large particle size is prepared. Separately, as a dielectric raw material included as an inhibitor in an internal electrode layer paste described later, a dielectric powder including dielectric particles with a relatively small particle size is prepared.

The dielectric powder included in the dielectric layer paste may have any intraparticle porosity. The intraparticle porosity may be, for example, 1.0% or more and 30% or less, or 1.0% or more and 24% or less.

To control the number ratio of the grains that fall under both the electrode-contacting grains and the porous grains to the electrode-contacting grains within 0.1% or more and 15.0% or less, the internal electrode layer paste needs to include an inhibitor with a controlled intraparticle porosity. Specifically, as the inhibitor, a dielectric powder including dielectric particles represented by the formula A²B²O₃ is used. The dielectric powder included as the inhibitor in the internal electrode layer paste has an intraparticle porosity (which may hereinafter be simply referred to as intraparticle porosity of the inhibitor) of 1.0% or more and 40% or less.

Methods of synthesizing a dielectric having BaTiO₃ as a main component generally include a solid phase method, an oxalate method, and a liquid phase method. Synthesis of the dielectric having BaTiO₃ as the main component using the liquid phase method among these methods is described below.

First, Ba(OH)₂ and TiCl₄ are mixed to give a mixture. This mixture undergoes a hydrothermal reaction to synthesize a dielectric powder including dielectric particles having BaTiO₃ as a main component. Resultant BaTiO₃ is washed with water and is dried.

The larger the particle size of the dielectric powder after it is dried, the higher the temperature of the hydrothermal reaction may be. Thus, the temperature for the preparation of the dielectric powder included in the dielectric layer paste is higher than the temperature for the preparation of the dielectric powder included in the internal electrode layer paste.

In the conventional liquid phase method, the above drying gives a dielectric powder.

However, in a situation where the dielectric powder having a small particle size included in the internal electrode layer paste is obtained, the number ratio of porous dielectric particles (which may hereinafter be referred to as intraparticle porosity) is high, because the temperature of the hydrothermal reaction is low. Specifically, the number ratio is about 60%. If such a dielectric powder is included as the inhibitor in the internal electrode layer paste for manufacture of a multilayer ceramic capacitor, the number ratio of the grains that fall under both the electrode-contacting grains and the porous grains to the electrode-contacting grains cannot be 15.0% or less.

Further calcination of the dried dielectric powder used as the inhibitor in the internal electrode layer paste can decrease the intraparticle porosity. A use of the dielectric powder with an intraparticle porosity decreased by the calcination as the inhibitor in the internal electrode layer paste to manufacture a multilayer ceramic capacitor enables the number ratio of the grains that fall under both the electrode-contacting grains and the porous grains to the electrode-contacting grains to be 0.1% or more and 15.0% or less. Moreover, the amount of the inhibitor with respect to 100 parts by weight metal powder included in the internal electrode layer paste is 8 parts by weight or more and 20 parts by weight or less.

Controlling all of the composition of the inhibitor included in the internal electrode layer paste, the intraparticle porosity of the inhibitor, and the amount of the inhibitor within the above ranges enables the number ratio of the grains that fall under both the electrode-contacting grains and the porous grains to the electrode-contacting grains to be 0.1% or more and 15.0% or less.

Even if the inhibitor is the dielectric powder including the dielectric particles represented by the formula A²B²O₃, too low an intraparticle porosity of the inhibitor readily causes an abnormal grain growth of the electrode-contacting grains at the time when the inhibitor is diffused from the internal electrode layers to the dielectric layers. The abnormal grain growth of the electrode-contacting grains is a cause of a structural defect. Thus, a multilayer ceramic capacitor eventually obtained readily has low reliability. In a situation where the amount of the inhibitor in the internal electrode layer paste is too large, the number ratio of the grains that fall under both the electrode-contacting grains and the porous grains to the electrode-contacting grains tends to be too high. In a situation where the amount of the inhibitor in the internal electrode layer paste is too small, the number ratio of the grains that fall under both the electrode-contacting grains and the porous grains to the electrode-contacting grains tends to be too low.

Because the particle size of the dielectric powder used as the inhibitor is small, it has been difficult to use a dielectric powder resulting from the conventional solid phase method as the inhibitor. Changing some conditions of the conventional solid phase method enables preparation of a dielectric powder that can be used as the inhibitor. Specifically, pulverization of a powder synthesized using the normal solid phase method or a powder synthesized under the same conditions except that the synthesis temperature is decreased from that of the normal solid phase method into a particle size that enables the powder to be used as the inhibitor can provide the dielectric powder that can be used as the inhibitor. Although the particle size that enables the powder to be used as the inhibitor is not limited, the particle size may be 50 nm or less.

Because the particle size of the dielectric powder used as the inhibitor is small, it has been difficult to use a dielectric powder resulting from the conventional oxalate method as the inhibitor. Changing some conditions of the conventional oxalate method enables preparation of a dielectric powder that can be used as the inhibitor. Specifically, pulverization of a powder synthesized using the normal oxalate method or a powder synthesized under the same conditions except that calcination is carried out at a temperature lower than that of the normal oxalate method into a particle size that enables the powder to be used as the inhibitor can provide the dielectric powder that can be used as the inhibitor. Although the particle size that enables the powder to be used as the inhibitor is not limited, the particle size may be 50 nm or less.

The dielectric layer paste may be prepared using any method. The dielectric layer paste can be prepared by, for example, turning the above dielectric powder into paint. The dielectric layer paste may be organic paint or aqueous paint.

In the present embodiment, the above dielectric powder may have any BET specific surface area. To respond to a requirement for thinning the dielectric layers 2, the BET specific surface area may be 6.0 m²/g or more.

In a situation where the dielectric layers 2 contain a component other than the above main component, a raw material of the component is prepared. As the raw material of the component, a simple oxide of the component, a complex oxide of the component, or a mixture of them can be used, similarly to the above components. Other than that, various compounds that become the above simple oxide or complex oxide by firing can be used.

The dielectric powder used for the preparation of the dielectric layer paste may have any average particle size. The average particle size is normally about 0.05 μm to about 0.20 μm.

In a situation where the dielectric layer paste is to be organic paint, the dielectric raw material and an organic vehicle are kneaded to give the organic paint. The organic vehicle is a mixture of an organic solvent and a binder dissolved therein. The binder may be of any type. The binder is appropriately selected from various binders (e.g., ethyl cellulose and polyvinyl butyral) normally used in this technical field. The organic solvent may be of any type. The organic solvent is appropriately selected from various organic solvents (e.g., terpineol, butyl carbitol, acetone, and toluene) according to a method of manufacturing the green chip.

In a situation where the dielectric layer paste is to be aqueous paint, the dielectric raw material and an aqueous vehicle are kneaded to give the aqueous paint. The aqueous vehicle is a mixture of water and a water-soluble binder, dispersant, or the like dissolved therein. The water-soluble binder may be of any type. The water-soluble binder is appropriately selected from various water-soluble binders (e.g., polyvinyl alcohol, cellulose, and water-soluble acrylic resin) normally used in this technical field.

The following description is based on the premise that the dielectric layer paste is organic paint.

To prepare the internal electrode layer paste, various conductive materials described above or various oxides, organic metal compounds, resinate, or the like that become the various conductive materials described above after firing; an organic vehicle described above; and the inhibitor described above are kneaded.

An external electrode paste is prepared using a method similar to the method of preparing the internal electrode layer paste described above. However, the external electrode paste may or may not include the inhibitor described above.

Each of the pastes described above may have any organic vehicle content. The organic vehicle content is a normal content of this technical field. Each paste has, for example, a binder content of about 1 wt % to about 5 wt % and a solvent content of about 10 wt % to about 50 wt %. Each paste may include additives selected from various dispersants, plasticizers, dielectrics, insulators, and the like as necessary. Each paste may have an additive content of 10 wt % or less in total.

In a situation where the printing method is used to prepare the green chip, the green chip is given by printing and laminating the dielectric layer paste and the internal electrode layer paste on substrates (e.g., PET), cutting the resultant product into a predetermined shape, and peeling the cut pieces off from the substrates.

In a situation where the sheet method is used to prepare the green chip, firstly green sheets are formed with the dielectric layer paste, and the internal electrode layer paste is printed on the green sheets. Then, the green sheets having the internal electrode layer paste printed are laminated, and this laminate is cut into a predetermined shape to give the green chip.

Before firing described later, the green chip undergoes a binder removal treatment. Binder removal conditions are not limited. The heating rate may be 5° C./hour to 300° C./hour. The holding temperature may be 180° C. to 900° C. The temperature holding time may be 0.5 hours to 48 hours. The binder removal atmosphere may be air or a reducing atmosphere.

The firing atmosphere for the green chip may be a reducing atmosphere. As an ambient gas for the reducing atmosphere, for example, a humidified mixed gas of N₂ and H₂ can be used. The oxygen partial pressure for firing can be appropriately determined according to the type of the conductive material in the internal electrode layer paste. In a situation where a base metal (e.g., Ni or a Ni alloy) is used as the conductive material in the internal electrode layer paste, the oxygen partial pressure is preferably 10⁻¹¹ to 10⁻⁸ MPa.

The heating rate during firing may be 10 k° C./hour or more and 500 k° C./hour or less. The lower the heating rate, the higher the number ratio of the porous grains in the dielectric layers of the multilayer ceramic capacitor eventually obtained tends to be.

The holding temperature during firing may be 1300° C. or less or may be 1000° C. to 1300° C. The temperature holding time during firing may be 0.2 to 8 hours or may be more 0.2 to 3 hours. In particular, that the holding temperature during firing is within the above range sufficiently readily densifies the dielectric layers 2 while preventing electrode disconnection due to abnormal sintering of the internal electrode layers 3 or a decrease in dielectric characteristics due to an excessive grain growth of the dielectric grains. The cooling rate after firing may be, for example, 50° C./hour to 8000° C./hour.

After being fired in the reducing atmosphere, the capacitor element body 10 may be annealed. Annealing is a treatment for reoxidizing the dielectric layers 2. Annealing readily extends the high-temperature load life of the multilayer ceramic capacitor 1.

The oxygen partial pressure of the annealing atmosphere may be 10⁻⁹ to 10⁻⁵ MPa. That the oxygen partial pressure is within the above range sufficiently readily reoxidizes the dielectric layers 2 while preventing oxidation of the internal electrode layers 3.

The holding temperature during annealing may be 1100° C. or less or may be 900° C. to 1100° C. That the holding temperature during annealing is within the above range sufficiently readily reoxidizes the dielectric layers 2 while preventing oxidation of the internal electrode layers 3. Consequently, the multilayer ceramic capacitor 1 readily has suitable insulation resistance and suitable high-temperature load life.

Note that, while annealing normally includes a heating process, a temperature holding process, and a cooling process, annealing may include only the heating process and the cooling process. That is, the temperature holding time may be 0. In this situation, the holding temperature is equivalent to a maximum temperature.

Annealing conditions other than the holding temperature are as follows. The temperature holding time during annealing may be 0 to 30 hours or may be 1 to 25 hours. The cooling rate during annealing may be 50° C./hour to 500° C./hour or may be 100° C./hour to 300° C./hour. As an ambient gas for annealing, a humidified N₂ gas or the like may be used.

In the binder removal treatment, firing, and annealing described above, any method of humidifying the N₂ gas, the mixed gas, or the like may be used. For humidification, a wetter or the like is used. In a situation where the wetter or the like is used, the water temperature may be about 5° C. to about 75° C.

The binder removal treatment, firing, and annealing may be carried out continuously or independently.

End surfaces of the capacitor element body 10 resulting as above are polished, and the external electrode paste is applied there and is baked to form the external electrodes 4. Any method of polishing the end surfaces may be used. Examples of such methods include barrel polishing and sandblasting. Further, surfaces of the external electrodes 4 may be provided with a coating layer by plating or the like as necessary.

The dielectric powder included as the inhibitor in the internal electrode layer paste is generally a fine powder having a particle size smaller than that of the dielectric powder included in the dielectric layer paste. It is difficult to improve the quality of such a fine powder, and the powder readily has an increased intraparticle porosity. Moreover, diffusion of the relatively low-quality inhibitor to the dielectric layers readily increases the number ratio of the porous grains to the electrode-contacting grains to readily decrease the reliability of the multilayer ceramic capacitor.

A decrease in the intraparticle porosity of the dielectric powder included as the inhibitor in the internal electrode layer paste makes it less likely for the number ratio of the porous grains to the electrode-contacting grains to increase even when the inhibitor is diffused to the dielectric layers.

A decrease in the inhibitor content of the internal electrode layer paste and an increase in the heating rate of the firing enable the internal electrodes to be sintered before the inhibitor is diffused to the dielectric layers to keep the inhibitor within the internal electrode layers. Consequently, the inhibitor is less readily diffused to the dielectric layers, and the number ratio of the porous grains to the electrode-contacting grains is less readily increased. Moreover, in a situation where the internal electrodes are sintered before the inhibitor is diffused to the dielectric layers, the internal electrode grains 3a readily include the inside-electrode dielectric grains 3b as shown in FIG. 2.

Therefore, the number ratio of the porous grains to the electrode-contacting grains is readily decreased, which readily improves the reliability of the multilayer ceramic capacitor.

The multilayer ceramic capacitor 1 of the present embodiment manufactured in such a manner is mounted on a printed circuit board or the like by soldering or the like and is used in various electronics.

Although the embodiment of the present disclosure has been described above, the present disclosure is not limited to the above embodiment and can be variously modified without departing from the gist of the present disclosure.

### EXAMPLES

Hereinafter, the present disclosure is described based on more detailed examples. However, the present disclosure is not limited to these examples.

### Example 1

As a raw material of a main component, a barium titanate powder (BaTiO₃) was prepared using a liquid phase method. The barium titanate powder had an intraparticle porosity of 24%.

Then, to the BaTiO₃ powder, which was the raw material of the main component, sintering aid, a binder, and an organic solvent were added. The BaTiO₃ powder (100 parts by weight), a SiO₂ powder as the sintering aid (0.4 parts by weight), a polyvinyl butyral resin as the binder (15 parts by weight), and ethanol as the organic solvent (100 parts by weight) were wet-mixed using a ball mill to turn them into a paste to give a dielectric layer paste. The dielectric layer paste was applied to carrier films and was dried to give ceramic green sheets.

Separately, an inhibitor was prepared. First, a barium titanate powder (BaTiO₃) with an intraparticle porosity of 60% was prepared using the liquid phase method. Then, the barium titanate powder underwent a heat treatment using an electric furnace. The heat treatment temperature was 900° C. The holding time of the heat treatment was 4 hours. Then, wet pulverization was carried out using a nylon pot mill with zirconia balls. After that, a heat treatment was carried out to decrease the intraparticle porosity. The temperature of the heat treatment after the wet pulverization was 150° C. The holding time of the heat treatment was 10 hours. Pulverization was carried out so that the average particle size was 50 nm to give the inhibitor powder. Note that the inhibitor powder had an intraparticle porosity of 26%.

Then, a Ni powder having an average particle size of 100 nm (100 parts by weight), ethyl cellulose as a binder (3 parts by weight), terpineol acetate as a dispersant (100 parts by weight), and the above inhibitor powder (20 parts by weight) were kneaded and were turned into slurry to give an internal electrode layer paste.

Using the internal electrode layer paste, electrode layers, which eventually became internal electrode layers, were printed in a predetermined pattern on the above ceramic green sheets. After the electrode layers were printed, the green sheets were peeled off from the PET films to give green sheets with the electrode layers. Then, the green sheets with the electrode layers were laminated, were adhered with pressure, and were cut to give multilayer bodies.

A method of checking the intraparticle porosity of each barium titanate powder was as follows. First, a transmission electron microscope photograph of the barium titanate powder was taken at a magnification of ×50,000 to ×100,000. At least three hundred powder particles included in the photograph were observed. The number of the photograph may have been one or may have been two or more. The number of powder particles with a pore among the observed powder particles was counted to calculate the intraparticle porosity of the barium titanate powder. In the transmission electron microscope photograph, pores looked dark.

After a binder removal treatment, firing and annealing were carried out under the following conditions to give capacitor element bodies as sintered bodies.

Conditions of the binder removal treatment were as follows. The heating rate was 25° C./hour. The holding temperature was 800° C. The temperature holding time was 8 hours. The atmosphere was a N₂+H₂ mixed gas (oxygen partial pressure was 10⁻¹² MPa). Conditions of the firing were as follows. The holding temperature was 1100° C. to 1300° C. The temperature holding time was 0.5 hours. The cooling rate was 800° C./hour. The ambient gas was a humidified N₂+H₂ mixed gas (oxygen partial pressure was 10⁻¹⁰ MPa). The heating rate was as shown in Table 1.

Conditions of the annealing were as follows. The heating rate was 200° C./hour. The holding temperature was 1000° C. The temperature holding time was 2 hours. The cooling rate was 200° C./hour. The ambient gas was a humidified N₂ gas (oxygen partial pressure was 10⁻⁷ MPa).

To humidify the ambient gases for the firing and the annealing, a wetter was used.

Then, end surfaces of the resultant capacitor element bodies were polished using sandblasting. Then, an external electrode paste containing glass frit and Cu was applied there. Baking was carried out to form external electrodes. This provided multilayer ceramic capacitor samples shown in FIG. 1.

Each resultant capacitor sample had a size of 2.00 mm×1.25 mm×1.25 mm. Dielectric layers had a thickness of 0.7 μm. The internal electrode layers had a thickness of 0.6 μm. The number of the dielectric layers interposed between the internal electrode layers was 260.

Methods of measuring the number ratio of porous grains to electrode-contacting grains, the number ratio of porous grains to electrode-noncontacting grains, and relative permittivity of the resultant capacitor sample were as follows. Moreover, a method of evaluating results of an accelerated test and a method of measuring the high-temperature load life were as follows.

### Porous Grains

First, the capacitor sample was polished so that a section near a center of the internal layers, i.e., a section that was parallel to an XY plane of FIG. 1 and was equally distant from two surfaces perpendicular to the Z-axis, was observed.

Then, two internal electrode layers 3 and a dielectric layer 2 interposed between them were extracted and were thinned.

Then, the thinned specimen was observed using a STEM at a magnification of ×500,000 or more and ×1,000,000 or less to obtain a STEM-HAADF image.

Whether each dielectric grain included in the dielectric layer 2 was an electrode-contacting grain or an electrode-noncontacting grain was identified. At the same time, whether each dielectric grain had a pore inside was identified. Note that, in the STEM-HAADF image, pores were observed as dark spots. All dark spots of the STEM-HAADF image were deemed to be pores.

The above measurement was carried out for a field of view in which at least ten electrode-contacting grains and at least forty electrode-noncontacting grains were included. As necessary, multiple STEM-HAADF images were obtained. Then, the number ratio of the porous grains to the electrode-contacting grains and the number ratio of the porous grains to the electrode-noncontacting grains were calculated. Table 1 shows the results.

### Accelerated Test

The accelerated test of the resultant multilayer ceramic capacitor sample was carried out at 180° C. in an electric field under application of 20 V/μm. The time it took for the insulation resistance to reach 1000 £2 or less was calculated. The accelerated test result was deemed good when the time was 15 hours or more.

### Relative Permittivity

A signal with a frequency of 1 kHz and an input signal level (measurement voltage) of 1 Vrms was applied to the resultant multilayer capacitor sample at room temperature using a digital LCR meter (4284A manufactured by YHP) to measure capacitance. Then, relative permittivity (without unit) was calculated using the thickness of the dielectric layer, the effective electrode area, and the measured capacitance. In the present example, a relative permittivity of 2200 or more and 2500 or less was deemed good.

### High-Temperature Load Life

A state in which a direct current of 10 V/μm was applied in an electric field at 125° C. to the resultant two thousand multilayer ceramic capacitor samples was held. Changes in the insulation resistance of the multilayer ceramic capacitor samples were observed. The multilayer ceramic capacitor samples were deemed to have good high-temperature load life when it took 20 hours or more from the start of application of the direct current for the insulation resistance to decrease by a factor of 10. In the present example, that the number ratio of the multilayer ceramic capacitor samples that did not have good high-temperature load life was less than 0.05% (falling below 1/2000) was deemed good.

### Comparative Example 1

Comparative Example 1 was conducted as in Example 1 except that no heat treatment was carried out at the time of preparation of an inhibitor.

### Examples 2 to 4

Examples 2 to 4 were conducted as in Example 1 except that the heat treatment temperature for preparation of an inhibitor was changed to 950° C. (Example 2), 1000° C. (Example 3), or 1050° C. (Example 4) to change the intraparticle porosity of the inhibitor and that the average particle size of the inhibitor was changed.

### Example 5

Example 5 was conducted as in Example 1 except that a solid phase method different from a conventional solid phase method in terms of what was described above was used instead of the liquid phase method for preparation of an inhibitor and that no heat treatment was carried out after the pulverization. Note that the synthesis temperature for the solid phase method was 1000° C. and that the holding time at the synthesis temperature was 2 hours. The resultant inhibitor had an intraparticle porosity of 2%.

### Comparative Example 2

Comparative Example 2 was conducted as in Example 1 except that the solid phase method different from the conventional solid phase method in terms of what was described above was used instead of the liquid phase method for preparation of an inhibitor and that no heat treatment was carried out after the pulverization. Note that the synthesis temperature for the solid phase method was 1100° C. and that the holding time at the synthesis temperature was 2 hours. The resultant inhibitor had an intraparticle porosity of 0.2%.

### Comparative Example 3

Comparative Example 3 was conducted as in Example 1 except that the inhibitor was replaced with a SiO₂ powder without pores inside.

### Comparative Example 4

Comparative Example 4 was conducted as in Example 1 except that no inhibitor was added.

Table 1 shows the test results of Examples 1 to 5 and Comparative Examples 1 to 4.

TABLE 1

| | Before firing | | | | | | Firing |
|---|---|---|---|---|---|---|---|
| | Inhibitor | | | | Main component | | condition |
| | | Intraparticle | Particle | Amount | | Intraparticle | Heating |
| | Composition | porosity | size | Parts by | | porosity | rate |
| Sample No. | Atomic ratio | % | nm | weight | Composition | % | k° C./hr |
| Comparative Example 1 | BaTiO₃ | 60 | 50 | 20 | BaTiO₃ | 24 | 10 |
| Example 1 | BaTiO₃ | 26 | 50 | 20 | BaTiO₃ | 24 | 10 |
| Example 2 | BaTiO₃ | 20 | 50 | 20 | BaTiO₃ | 24 | 10 |
| Example 3 | BaTiO₃ | 14 | 59 | 20 | BaTiO₃ | 24 | 10 |
| Example 4 | BaTiO₃ | 9 | 68 | 20 | BaTiO₃ | 24 | 10 |
| Example 5 | BaTiO₃ | 2 | 50 | 20 | BaTiO₃ | 24 | 10 |
| Comparative Example 2 | BaTiO₃ | 0.2 | 50 | 20 | BaTiO₃ | 24 | 10 |
| Comparative Example 3 | SiO₂ | 0 | 50 | 20 | BaTiO₃ | 24 | 10 |

| | | | | |
|---|---|---|---|---|
| Comparative Example 4 | N/A | BaTiO₃ | 24 | 10 |

| | After firing | | | | |
|---|---|---|---|---|---|
| | Electrode- | Electrode- | | | |
| | contacting | noncontacting | | | |
| | grains | grains | Characteristics | | |
| | Number ratio | Number ratio | | | High- |
| | of porous | of porous | Accelerated | | temperature |
| | grains | grains | test | Relative | load life |
| Sample No. | % | % | hr | permittivity | defect rate |
| Comparative Example 1 | 23.0 | 19.1 | 4 | 2000 | 5/2000 |
| Example 1 | 14.6 | 18.4 | 15 | 2200 | 0/2000 |
| Example 2 | 10.0 | 17.2 | 16 | 2200 | 0/2000 |
| Example 3 | 8.2 | 15.8 | 16 | 2210 | 0/2000 |
| Example 4 | 6.8 | 14.8 | 17 | 2220 | 0/2000 |
| Example 5 | 5.0 | 13.2 | 17 | 2200 | 0/2000 |
| Comparative Example 2 | 0.0 | 14.0 | 5 | 2550 | 12/2000 |
| Comparative Example 3 | 0.0 | 14.8 | 1 | 1600 | 9/2000 |

| | | | |
|---|---|---|---|
| Comparative Example 4 | 0.0 | 14.0 | Unmeasurable |

Table 1 shows Examples and Comparative Examples, in which mainly the intraparticle porosity of the inhibitors was changed to change the number ratios of the porous grains. Examples 1 to 5, in which mainly the intraparticle porosity of the inhibitors was changed to control the number ratio of the porous grains to the electrode-contacting grains within a predetermined range, had good characteristics.

In contrast, in Comparative Example 1, in which the number ratio of the porous grains to the electrode-contacting grains was too high, the result of the accelerated test was not good; relative permittivity was too low; and high-temperature load life was worse. In Comparative Example 2, in which the number ratio of the porous grains to the electrode-contacting grains was too low, the result of the accelerated test was not good; relative permittivity was too high; and high-temperature load life was worse. In Comparative Example 3, in which the SiO₂ powder was used as the inhibitor, the electrode-contacting grains included no porous grains. Moreover, the result of the accelerated test was not good; relative permittivity was too low; and high-temperature load life was worse. It was assumed that this was because the use of the SiO₂ powder as the inhibitor generated a different phase mainly containing Si near the internal electrode layers. In Comparative Example 4, in which no inhibitor was used, an internal layer crack was caused, and characteristics were unmeasurable.

### Examples 11 to 15 and Comparative Examples 11 and 12

In Examples 11 to 15 and Comparative Examples 11 and 12, as a raw material of a main component, a barium titanate powder (BaTiO₃) was prepared using the solid phase method. The barium titanate powder, which was the raw material of the main component, had an intraparticle porosity of 1%. Examples 11 to 15 and Comparative Examples 11 and 12 were conducted as in Examples 1 to 5 and Comparative Examples 1 and 2 except for the main component. Table 2 shows the test results of Examples 11 to 15 and Comparative Examples 11 and 12.

TABLE 2

| | Before firing | | | | | | Firing |
|---|---|---|---|---|---|---|---|
| | Inhibitor | | | | Main component | | condition |
| | | Intraparticle | Particle | Amount | | Intraparticle | Heating |
| | Composition | porosity | size | Parts by | | porosity | rate |
| Sample No. | Atomic ratio | % | nm | weight | Composition | % | k° C./hr |
| Comparative Example 11 | BaTiO₃ | 60 | 50 | 20 | BaTiO₃ | 1 | 10 |
| Example 11 | BaTiO₃ | 26 | 50 | 20 | BaTiO₃ | 1 | 10 |
| Example 12 | BaTiO₃ | 20 | 50 | 20 | BaTiO₃ | 1 | 10 |
| Example 13 | BaTiO₃ | 14 | 59 | 20 | BaTiO₃ | 1 | 10 |
| Example 14 | BaTiO₃ | 9 | 68 | 20 | BaTiO₃ | 1 | 10 |
| Example 15 | BaTiO₃ | 2 | 50 | 20 | BaTiO₃ | 1 | 10 |
| Comparative Example 12 | BaTiO₃ | 0.2 | 50 | 20 | BaTiO₃ | 1 | 10 |

| | After firing | | | | |
|---|---|---|---|---|---|
| | Electrode- | Electrode- | | | |
| | contacting | noncontacting | | | |
| | grains | grains | Characteristics | | |
| | Number ratio | Number ratio | | | High- |
| | of porous | of porous | Accelerated | | temperature |
| | grains | grains | test | Relative | load life |
| Sample No. | % | % | hr | permittivity | defect rate |
| Comparative Example 11 | 22.4 | 8.8 | 5 | 2210 | 4/2000 |
| Example 11 | 9.4 | 4.3 | 17 | 2330 | 0/2000 |
| Example 12 | 7.6 | 3.5 | 18 | 2320 | 0/2000 |
| Example 13 | 5.2 | 3.2 | 18 | 2310 | 0/2000 |
| Example 14 | 3.5 | 2.1 | 19 | 2380 | 0/2000 |
| Example 15 | 1.4 | 0.1 | 19 | 2310 | 0/2000 |
| Comparative Example 12 | 0.0 | 0.1 | 2 | 2580 | 11/2000 |

According to Table 2, even if the intraparticle porosity of the barium titanate powder as the raw material of the main component was decreased and mainly the number ratio of the porous grains to the electrode-noncontacting grains was decreased from those of each Example or Comparative Example shown in Table 1, a tendency similar to that of each Example or Comparative Example shown in Table 1 was observed.

It was confirmed, particularly with regard to the accelerated test, that the lower the number ratio of the porous grains to the electrode-noncontacting grains, the better the result tended to be, and that influence of the number ratio of the porous grains to the electrode-contacting grains was larger than influence of the number ratio of the porous grains to the electrode-noncontacting grains.

### Examples 21 to 24 and Comparative Examples 21 to 28

Examples 21 to 24 and Comparative Examples 21 to 28 were conducted as in Example 1, Example 5, Comparative Example 1, or Comparative Example 2 except that the heating rate of firing and/or the amount of an inhibitor was changed. Table 3 shows the results.

TABLE 3

| | Before firing | | | | | | Firing |
|---|---|---|---|---|---|---|---|
| | Inhibitor | | | | Main component | | condition |
| | | Intraparticle | Particle | Amount | | Intraparticle | Heating |
| | Composition | porosity | size | Parts by | | porosity | rate |
| Sample No. | Atomic ratio | % | nm | weight | Composition | % | k° C./hr |
| Comparative Example 21 | BaTiO₃ | 60 | 50 | 20 | BaTiO₃ | 24 | 0.2 |
| Comparative Example 1 | BaTiO₃ | 60 | 50 | 20 | BaTiO₃ | 24 | 10 |
| Comparative Example 22 | BaTiO₃ | 60 | 50 | 20 | BaTiO₃ | 24 | 500 |
| Comparative Example 23 | BaTiO₃ | 60 | 50 | 8 | BaTiO₃ | 24 | 500 |
| Comparative Example 24 | BaTiO₃ | 26 | 50 | 20 | BaTiO₃ | 24 | 0.2 |
| Example 1 | BaTiO₃ | 26 | 50 | 20 | BaTiO₃ | 24 | 10 |
| Example 21 | BaTiO₃ | 26 | 50 | 20 | BaTiO₃ | 24 | 500 |
| Example 22 | BaTiO₃ | 26 | 50 | 8 | BaTiO₃ | 24 | 500 |
| Comparative Example 25 | BaTiO₃ | 2 | 50 | 20 | BaTiO₃ | 24 | 0.2 |
| Example 5 | BaTiO₃ | 2 | 50 | 20 | BaTiO₃ | 24 | 10 |
| Example 23 | BaTiO₃ | 2 | 50 | 20 | BaTiO₃ | 24 | 500 |
| Example 24 | BaTiO₃ | 2 | 50 | 8 | BaTiO₃ | 24 | 500 |
| Comparative Example 26 | BaTiO₃ | 0.2 | 50 | 20 | BaTiO₃ | 24 | 0.2 |
| Comparative Example 2 | BaTiO₃ | 0.2 | 50 | 20 | BaTiO₃ | 24 | 10 |
| Comparative Example 27 | BaTiO₃ | 0.2 | 50 | 20 | BaTiO₃ | 24 | 500 |
| Comparative Example 28 | BaTiO₃ | 0.2 | 50 | 8 | BaTiO₃ | 24 | 500 |

| | After firing | | | | |
|---|---|---|---|---|---|
| | Electrode- | Electrode- | | | |
| | contacting | noncontacting | | | |
| | grains | grains | Characteristics | | |
| | Number ratio | Number ratio | | | High- |
| | of porous | of porous | Accelerated | | temperature |
| | grains | grains | test | Relative | load life |
| Sample No. | % | % | hr | permittivity | defect rate |
| Comparative Example 21 | 34.0 | 21.0 | 2 | 2150 | 15/2000 |
| Comparative Example 1 | 23.0 | 19.1 | 5 | 2000 | 5/2000 |
| Comparative Example 22 | 19.0 | 17.0 | 7 | 2100 | 4/2000 |
| Comparative Example 23 | 18.0 | 16.9 | 7 | 2100 | 4/2000 |
| Comparative Example 24 | 21.0 | 20.0 | 14 | 2280 | 2/2000 |
| Example 1 | 14.6 | 18.4 | 15 | 2200 | 0/2000 |
| Example 21 | 8.2 | 16.8 | 16 | 2210 | 0/2000 |
| Example 22 | 5.2 | 13.2 | 17 | 2210 | 0/2000 |
| Comparative Example 25 | 18.0 | 14.4 | 1 | 2600 | 16/2000 |
| Example 5 | 5.0 | 14.7 | 17 | 2200 | 0/2000 |
| Example 23 | 2.0 | 12.1 | 19 | 2300 | 0/2000 |
| Example 24 | 0.2 | 10.7 | 20 | 2300 | 0/2000 |
| Comparative Example 26 | 0.0 | 16.0 | 3 | 2800 | 21/2000 |
| Comparative Example 2 | 0.0 | 14.0 | 5 | 2550 | 12/2000 |
| Comparative Example 27 | 0.0 | 11.0 | 8 | 2430 | 6/2000 |
| Comparative Example 28 | 0.0 | 10.0 | 11 | 2380 | 4/2000 |

The higher the heating rate of firing, the lower the number ratios of the porous grains tended to be. Moreover, when the number ratio of the porous grains to the electrode-contacting grains was within the predetermined range, good characteristics were observed. In particular, the higher the heating rate of firing, the better the accelerated test results tended to be.

In each Comparative Example in which the heating rate was 0.2 k° C./hr, the number ratio of the porous grains to the electrode-contacting grains was high, because the inhibitor was more readily diffused to the dielectric layers and the inhibitor with a pore inside became the electrode-contacting grains.

### Examples 31 to 40

Examples 31 to 40 were conducted as in Example 1 or Example 5 except that mainly the compositions of an inhibitor and a main component were changed. Table 4 shows the results. In Examples 31 and 32, Ba:Sr=97:3 was satisfied in atomic ratio. In Examples 33 and 34, Ba:Ca=97:3 was satisfied in atomic ratio. In Examples 35 and 36, Ti:Zr=95:5 was satisfied in atomic ratio. In Examples 37 and 38, Ba:Sr=97:3 and Ti:Zr=95:5 were satisfied in atomic ratio. In Examples 39 and 40, Ba:Ca=97:3 and Ti:Zr=95:5 were satisfied in atomic ratio.

TABLE 4

| | Before firing | | | | | |
|---|---|---|---|---|---|---|
| | Inhibitor | | | | Main component | |
| | | Intraparticle | Particle | Amount | | Intraparticle |
| | Composition | porosity | size | Parts by | | porosity |
| Sample No. | Atomic ratio | % | nm | weight | Composition | % |
| Example 1 | BaTiO₃ | 26 | 50 | 20 | BaTiO₃ | 24 |
| Example 5 | BaTiO₃ | 2 | 50 | 20 | BaTiO₃ | 24 |
| Example 31 | (Ba, Sr)TiO₃ | 28 | 48 | 20 | (Ba, Sr)TiO₃ | 26 |
| Example 32 | (Ba, Sr)TiO₃ | 2 | 52 | 20 | (Ba, Sr)TiO₃ | 26 |
| Example 33 | (Ba, Ca)TiO₃ | 32 | 48 | 20 | (Ba, Ca)TiO₃ | 28 |
| Example 34 | (Ba, Ca)TiO₃ | 2 | 54 | 20 | (Ba, Ca)TiO₃ | 28 |
| Example 35 | Ba(Ti, Zr)O₃ | 20 | 42 | 20 | Ba(Ti, Zr)O₃ | 23 |
| Example 36 | Ba(Ti, Zr)O₃ | 3 | 48 | 20 | Ba(Ti, Zr)O₃ | 23 |
| Example 37 | (Ba, Sr)(Ti, Zr)O₃ | 27 | 50 | 20 | (Ba, Sr)(Ti, Zr)O₃ | 25 |
| Example 38 | (Ba, Sr)(Ti, Zr)O₃ | 2 | 56 | 20 | (Ba, Sr)(Ti, Zr)O₃ | 25 |
| Example 39 | (Ba, Ca)(Ti, Zr)O₃ | 30 | 50 | 20 | (Ba, Ca)(Ti, Zr)O₃ | 26 |
| Example 40 | (Ba, Ca)(Ti, Zr)O₃ | 3 | 48 | 20 | (Ba, Ca)(Ti, Zr)O₃ | 26 |

| | | After firing | | | | |
|---|---|---|---|---|---|---|
| | | Electrode- | Electrode- | | | |
| | | contacting | noncontacting | | | |
| | Firing | grains | grains | Characteristics | | |
| | condition | Number ratio | Number ratio | | | High- |
| | Heating | of porous | of porous | Accelerated | | temperature |
| | rate | grains | grains | test | Relative | load life |
| Sample No. | k° C./hr | % | % | hr | permittivity | defect rate |
| Example 1 | 10 | 14.6 | 18.4 | 15 | 2200 | 0/2000 |
| Example 5 | 10 | 5.0 | 14.7 | 17 | 2200 | 0/2000 |
| Example 31 | 10 | 14.5 | 17.9 | 18 | 2340 | 0/2000 |
| Example 32 | 10 | 0.6 | 14.4 | 25 | 2350 | 0/2000 |
| Example 33 | 10 | 14.7 | 18.4 | 17 | 2310 | 0/2000 |
| Example 34 | 10 | 0.8 | 13.8 | 23 | 2300 | 0/2000 |
| Example 35 | 10 | 9.0 | 11.5 | 23 | 2300 | 0/2000 |
| Example 36 | 10 | 0.8 | 10.1 | 29 | 2290 | 0/2000 |
| Example 37 | 10 | 12.0 | 15.0 | 20 | 2230 | 0/2000 |
| Example 38 | 10 | 0.7 | 14.0 | 28 | 2250 | 0/2000 |
| Example 39 | 10 | 13.0 | 16.0 | 21 | 2210 | 0/2000 |
| Example 40 | 10 | 0.1 | 14.0 | 30 | 2220 | 0/2000 |

According to Table 4, even if the compositions of the inhibitor and the main component were changed, provided that other parameters remained, similar results were provided.

### REFERENCE NUMERALS

1 . . . multilayer ceramic capacitor
2 . . . dielectric layer
2a . . . electrode-contacting grain
2a1 . . . non-porous grain (electrode-contacting grain)
2a2 . . . porous grain (electrode-contacting grain)
2b . . . electrode-noncontacting grain
2b1 . . . non-porous grain (electrode-noncontacting grain)
2b2 . . . porous grain (electrode-noncontacting grain)
3 . . . internal electrode layer
3a . . . internal electrode grain
3b . . . inside-electrode dielectric grain
4 . . . external electrode
10 . . . capacitor element body

What is claimed is:

1. A multilayer ceramic electronic device comprising:
an element body comprising a dielectric layer and an internal electrode layer, the dielectric layer and the internal electrode layer being laminated,
wherein
the dielectric layer comprises dielectric grains comprising a main component represented by a formula A¹B¹O₃, where A¹ comprises Ba and at least one selected from the group consisting of Ca and Sr or comprises only Ba, and B¹ comprises Ti and Zr or comprises only Ti,
the dielectric grains comprise electrode-contacting grains in contact with the internal electrode layer and porous grains having a pore in a section parallel to a lamination direction, and
a number ratio of the dielectric grains that fall under both the electrode-contacting grains and the porous grains to the electrode-contacting grains is 0.1% or more and 15.0% or less.

2. The multilayer ceramic electronic device according to claim 1, wherein
the dielectric layer has a thickness of 1 μm or less, and
the number of the dielectric layer is 100 or more.

3. The multilayer ceramic electronic device according to claim 1, wherein
the dielectric grains comprise electrode-noncontacting grains not in contact with the internal electrode layer in the section parallel to the lamination direction, and
a number ratio of the dielectric grains that fall under both the electrode-noncontacting grains and the porous grains to the electrode-noncontacting grains is 0.1% or more and 15% or less.

4. The multilayer ceramic electronic device according to claim 1, wherein the internal electrode layer comprises an inside-electrode dielectric grain comprising a main component represented by a formula A²B²O₃, where A² comprises Ba and at least one selected from the group consisting of Ca and Sr or comprises only Ba, and B² comprises Ti and Zr or comprises only Ti.

5. The multilayer ceramic electronic device according to claim 4, wherein A²B²O₃ and A¹B¹O₃ are substantially the same.

6. The multilayer ceramic electronic device according to claim 4, wherein A²B²O₃ comprises BaTiO₃.

7. A method of manufacturing a multilayer ceramic electronic device, comprising:
forming an internal electrode layer on a ceramic green sheet using an internal electrode layer paste,
wherein
the internal electrode layer paste comprises a metal powder and an inhibitor,
the inhibitor comprises dielectric particles represented by a formula A²B²O₃, where A² comprises Ba and at least one selected from the group consisting of Ca and Sr or comprises only Ba, and B² comprises Ti and Zr or comprises only Ti,
the dielectric particles comprise porous dielectric particles having a pore inside,
a number ratio of the porous dielectric particles to the dielectric particles is 1.0% or more and 40% or less, and
an amount of the inhibitor is 8 parts by weight or more and 20 parts by weight or less with respect to 100 parts by weight of the metal powder.

8. The method of manufacturing a multilayer ceramic electronic device according to claim 7, wherein A²B²O₃ comprises BaTiO₃.
